(19) United States
(12) Patent Application Publication
(10) Pub. No.: US 2005/0254240 A1
(43) Pub. Date: Nov. 17, 2005

(54) Multifunction LED taillight

(76) Inventors: Duwaine Walt Lawrence, Brooklyn, NY (US); Garth O'Neil Lawrence, Brooklyn, NY (US)

Correspondence Address: Duwaine Lawrence, 627 East 77 Street, Brooklyn, NY, 11236, US

(21) Appl. No.: 10/843,152

(22) Filed: May 12, 2004

(51) Int. Cl. F21V 9/00; F21V 7/00

(52) U.S. Cl. 362/231

(57) ABSTRACT

The multifunction LED tail-light is illuminated by multi colored light emitting diodes (LED). The taillight is divided into seamless sections; there are no visible partition to indicate where one section starts and the other section ends. Each section of the light will react to specific events (eg. Indicator turns on) by emitting a specific color. There will be a section that reacts when the break is applied, when the park light is turned on, when the indicator and/or hazard lights are turned on and when the vehicle is in reverse. However, when only one event is triggered, the entire taillight will illuminate in the specific color that signifies that event

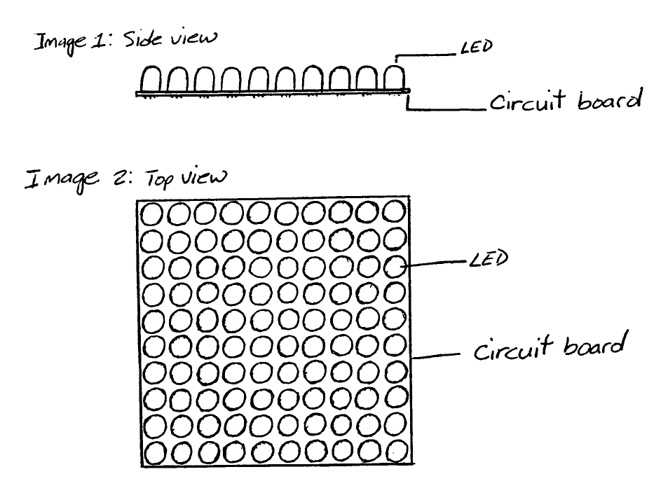

### TECHNICAL DESCRIPTION

The Multifunction LED (light emitting diode) Taillight will perform the same functions that a standard vehicle taillight performs. Like a standard taillight, the Multifunction LED Taillight is powered by the vehicle's battery. The light will illuminate when the vehicle's park lights are on.

The light will illuminate brighter when the vehicle's breaks are applied.

When the vehicle is in reverse, the light will illuminate in a color that indicate that the vehicle is in reverse, The light will flash on and off when the vehicle's indicator and/or hazard lights are on.

What Makes the Multifunction LED Taillight Different

The difference between the Multifunction LED Taillight and a standard taillight is in its design. The Multifunction LED Taillight is made from multi colored LED's that are selectively and seamlessly placed on a circuit board. The number of LED's and the size and shape of the circuit board will vary according to the make of the vehicle for which the light is design.

The Multifunction LED Taillight is divided into sections. Each section is seamless; there are no visible partitions to indicate where one section starts and the other section ends. Each section of the light will react to specific events by either emitting a specific color light, changing the intensity of the emitted light or by flashing on and off. There will be a section of the taillight that reacts when the break is applied, when the park light is turned on, when the indicator and/or hazard lights are turned on and when the vehicle is in reverse.

However, when only one event is triggered, the entire taillight including all sections will illuminate in the specific color that signifies that event.

If a second event is triggered simultaneously, a section of the taillight will illuminate to indicate the second event, while the other portion of the taillight continues to illuminate in the color that specifies the prior event.

### FURTHER DESCRIPTION OF THE ABOVE

If only the vehicle's park light is turned on, all the sections of the taillight will illuminate in the same color.

If the vehicle's break is then applied while the park light is on, the entire taillight, including all sections will get brighter.

If the vehicle's break is applied while the vehicle's turn signal and/or hazard light is on, then one section of the light will blink on and off while the other sections stay solidly illuminated.

When the vehicle is in reverse, one section will change to a color that indicates that the vehicle is in reverse. If the vehicle's brake is applied while the vehicle is in reverse, the other sections of the light will brightly illuminate to indicate that the brake is being applied, while one section continue to illuminate in a color that indicate that the vehicle is in reverse.

In the event that the vehicle is in reverse, with the brake applied and the indicator and/or hazard lights are on, then one section of the light will blink on and off, another section will illuminate in a color that will indicate that the vehicle is in reverse and another section of the light will brightly illuminate to indicate that the brake is applied.

The multicolored LED taillight will react in the same manner regardless of the sequence in which the particular events are triggered.

1. We claim that our invention uses multicolored light emitting diode's (LED) to perform all the functions of a conventional vehicle's taillight by emitting specific colors to indicate when specific events (eg. Break, park, hazard, indicator and reverse lights) are triggered.
a. Our invention as in claim 1 will signal different events by either emitting a specific color light, increase intensity of the emitted light or flash on and off.
b. Our invention as in claim 1 is made up of seamless sections with each section reacting to a specific event.
c. Our invention as in claim 1 with all sections will illuminate in one color if only one event is being triggered.
d. Our invention as in claim 1 will have specific sections illuminating to indicate specific events when two or more events are triggered simultaneously.

2. A circuit board populated with LED's and all its components will perform the function of break light, park light, reverse light, turn-signal (indicator) and hazard-light, independently and/or simultaneously if and when triggered. Our circuit board populated with LED's and all its components can vary in size and will also work as a side marker light.
e. A circuit as in claim 2 is placed in a housing that can be manufactures in any shape desired.
f. The circuit board as in claim 2 can itself be manufactured in to any desirable shape or configuration.
g. A circuit board populated with LED's as in claim 2 will perform all the functions of a vehicle's taillight.
h. Our invention as in claims 1 and 2 can be placed in different shape and size housing and be used as other accessory lights,
i. Our invention as in claims 1 and 2 can be used as a side marker light.
